(19) United States
(12) Patent Application Publication
(10) Pub. No.: US 2020/0161958 A1
(43) Pub. Date: May 21, 2020

(54) CIRCUIT AND METHOD FOR PASS TRANSISTOR SHARING IN VOLTAGE REGULATORS

(71) Applicant: Vidatronic Inc., College Station, TX (US)

(72) Inventors: Sameh Assem IBRAHIM, Cairo (EG); Faisal Abdellatif Elseddeek HUSSIEN, Cairo (EG); Mohamed Mostafa Saber ABOUDINA, Giza (EG); Moises Emanuel ROBINSON, College Station, TX (US); He HU, Bryan, TX (US)

(73) Assignee: Vidatronic Inc., College Station, TX (US)

(21) Appl. No.: 15/928,071

(22) Filed: Mar. 21, 2018

(51) Int. Cl. H02M 1/08; G05F 1/575; H02M 3/158

(52) U.S. Cl. CPC H02M 1/08; H02M 2001/0045; H02M 3/158; G05F 1/575

(57) ABSTRACT

A voltage regulator includes a load detection controller for detecting whether an output capacitor is present at an output of the voltage regulator; a digital controller for selecting a functional state of the voltage regulator based on a signal from the load detection controller; a first feedback loop for regulation when the output capacitor is not present; a second feedback loop for regulation when the capacitance output capacitor is present; and a first pass transistor shared by the load detection controller, the first feedback loop, and the second feedback loop, wherein the first pass transistor is configured to work with the first or second feedback loop selected for regulation based on the functional state of the voltage regulator.

### BACKGROUND

A voltage regulator is a circuit that converts an unregulated DC supply into a well-regulated one. The output DC level can be higher than, lower than, or equal to the input level. The voltage regulator can be a linear regulator or a switching one. The power delivering capabilities of a voltage regulator is determined by the area of its pass transistor. The larger the pass transistor, the more power the voltage regulator can deliver. As a result, usually the silicon area consumed by an integrated voltage regulator is dominated by the area of its pass transistor. The presence of this powerful device at the output of the voltage regulator can serve several applications and not only power delivery.

FIG. 1 shows a prior art linear voltage regulator. The voltage regulator needs an output load capacitor (101) with a capacitance value larger than a threshold (e.g., 47 μF) for it to be stable. Also, the pass transistor (102) is used for regulation only, whereas a separate circuit (103) is used for active discharge. This results in a limitation in performance and an increase in the area of the pass transistor. Performance is limited because either the area of the pass transistor is compromised to include the discharge circuit, or a small discharge circuit is used, which would result in a large discharge time.

FIG. 2 shows another prior art linear regulator. It can work with an output load capacitor (201) range of 0 to 10 nF with good stability. The pass transistor (202) is used for regulation, and a separate circuit (203) is used for load detection. This also presents a limitation in the load detection accuracy if a small detection circuit is used, or an area overhead if a large detection circuit is used.

FIG. 1 (100) and FIG. 2 (200) disclose prior art linear regulators, wherein the pass transistors are used merely for regulation and separate circuits are needed for either active discharge or load detection. Such regulators suffer from increased area overhead and/or degradation of performance of these auxiliary circuits.

### SUMMARY

In general, embodiments of the invention relate to novel architectures to enhance the performance of regulator auxiliary circuits and reduce the area overhead by sharing the pass transistor between different tasks.

One aspect of the invention relates to voltage regulators. A voltage regulator in accordance with one embodiment of the invention includes a load detection controller for detecting whether an output capacitor is present at an output of the voltage regulator; a digital controller for selecting a functional state of the voltage regulator based on a signal from the load detection controller; a first feedback loop for regulation when the output capacitor is not present; a second feedback loop for regulation when the capacitance output capacitor is present; and a first pass transistor shared by the load detection controller, the first feedback loop, and the second feedback loop, wherein the first pass transistor is configured to work with the first or second feedback loop selected for regulation based on the functional state of the voltage regulator. The first feedback loop and the second feedback loop may use the same feedback divider. The first pass transistor may be an NMOS transistor, a PMOS transistor, an NPN transistor, a PNP transistor, or a FinFET transistor. The load detection controller controls a gate of the first pass transistor to generate a voltage ramp at the output and uses an output of a current sensor to determine whether the output capacitor is higher than certain threshold or not.

In accordance with some embodiments of the invention, a voltage regulator may further comprise a discharge controller to be used during shutdown, wherein the discharge controller is configured to use the first pass transistor to discharge an output. The discharge controller uses a circuit at an input of the first pass transistor to disconnect the first pass transistor from an input supply and to connect the first pass transistor to ground, thereby allowing the output to be discharged via the first pass transistor.

In accordance with some embodiments of the invention, a voltage regulator may further comprise a second pass transistor and a third feedback loop, wherein the first pass transistor and the second pass transistor cooperate to form a switching regulator, and wherein the third feedback loop functions as a switching feedback loop. The first pass transistor may be a PMOS transistor, a PNP transistor, or a FinFET transistor. The second pass transistor may be an NMOS transistor, an NPN transistor, or a FinFET transistor.

One aspect of the invention relates to linear voltage regulators. A linear voltage regulator in accordance with one embodiment of the invention comprises a pass transistor split into at least two parts, a larger part used for voltage regulation and a smaller part used for overshoot/undershoot regulation; an overshoot/undershoot block to detect overshoot/undershoot in an output voltage, wherein the overshoot/undershoot block comprises an overshoot controller and an undershoot controller; and a feedback controller that comprises an error amplifier and a voltage reference. The pass transistor is an NMOS transistor, a PMOS transistor, an NPN transistor, a PNP transistor, or a FinFET transistor. The feedback controller comprises a digital controller to generate different enable signals, a load detector to determine the feedback loop required based on the output load capacitor, or a shutdown circuit. The overshoot detector comprises a combination of resistors and transistors that generates a first signal/indication (e.g., a high voltage signal) when the regulator output quickly rises over a regulation threshold, and the undershoot detector is a combination of resistors and transistors that generates a second signal/indication (e.g., a low voltage signal) when the regulator output quickly drops under a regulation threshold.

One aspect of the invention relates to methods for regulating output voltage of any voltage regulator of the invention. A method in accordance with one embodiment of the invention comprises detecting whether the output capacitor is present at the output using the load detection controller and generating a signal; selecting a functional state based on the signal; and regulating the output voltage, using the first feedback loop and the first pass transistor when the output capacitor is not present, or using the second feedback loop and the first pass transistor when the output capacitor is present.

In accordance with some embodiments of the invention, a method may further comprise discharging a voltage via the first pass transistor under the control of a discharge controller.

In accordance with some embodiments of the invention, the voltage regulator further comprises a second pass transistor and a third feedback loop, wherein the first pass transistor and the second pass transistor cooperate to form a switching regulator, and wherein the third feedback loop functions as a switching feedback loop, the method may further comprise regulating the output voltage using the switching regulator. A method may further comprise discharging a voltage via the first or second pass transistor under the control of a discharge controller.

Other aspects of the invention would become apparent with the following detailed description and the accompanying drawings.

### BRIEF DESCRIPTION OF DRAWINGS

The appended drawings illustrate several embodiments of the invention and are not to be considered limiting of its scope, for the invention may admit to other equally effective embodiments.

FIG. 1 shows a schematic block level circuit diagram of a prior art linear regulator circuit with an output load capacitor.

FIG. 2 shows a schematic block level circuit diagram of a prior art linear regulator circuit with little or no output load capacitor.

FIG. 3 shows a schematic block level circuit diagram of a linear regulator circuit with a pass transistor shared between different tasks.

FIG. 4 shows an example state diagram of a linear regulator with a pass transistor shared between different tasks.

FIG. 5 shows a schematic block level circuit diagram of a merged linear and switching regulator circuit with the pass transistor shared between different tasks.

FIG. 6 shows a schematic block level circuit diagram of a linear regulator with part of the pass transistor shared between different tasks.

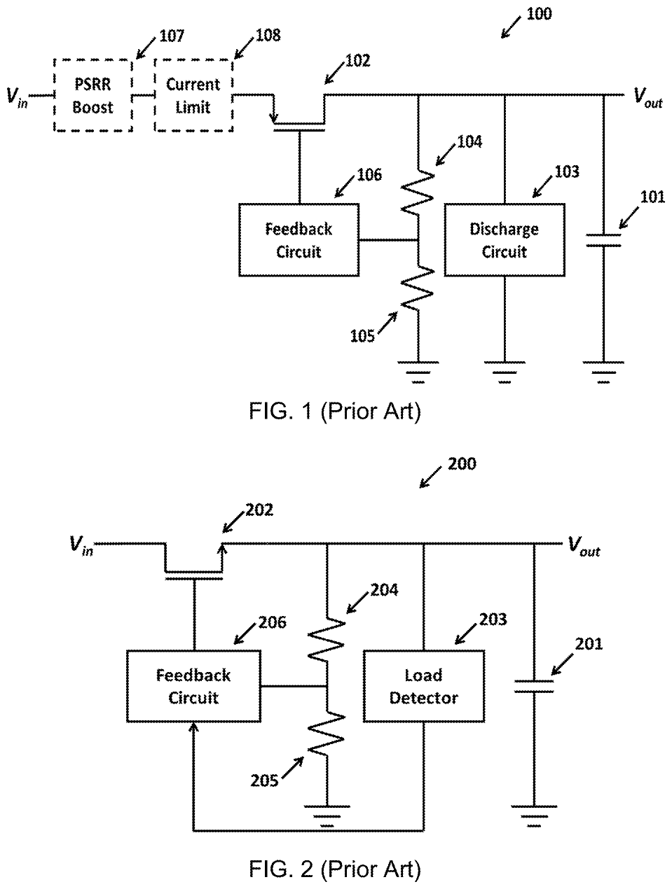

### DETAILED DESCRIPTION

Aspects of the present disclosure are shown in the attached drawings and described below. In the description, like or identical reference numerals are used to identify common or similar elements. The drawings are not necessarily to scale, and certain features may be shown exaggerated in scale or in schematic in the interest of clarity and conciseness.

Embodiments of the invention relate to sharing a pass transistor or part of a pass transistor in a linear and/or switching regulator to perform multiple tasks. In some embodiments of the invention, a pass transistor is used for load detection and regulation in a linear and/or switching regulator. In some embodiments of the invention, a pass transistor is used to allow stability for any load capacitor. In some embodiments of the invention, a pass transistor is used to enhance overshoot/undershoot performance. With prior art regulators, separate devices are needed for load detection, stability of regulators with output capacitor, stability of regulators without an output capacitor, and/or overshoot/undershoot performance enhancement. Therefore, compared with the prior art regulators, embodiments of the invention are simpler, more versatile, and more robust. Those skilled in the art, with the benefit of this disclosure, will appreciate that same or similar features disclosed herein are equally applicable to any system, operation of which requires a large pass transistor for output regulation.

In accordance with embodiments of the invention, the shared pass transistor can be an NMOS transistor, a PMOS transistor, a FinFET device, or a bipolar junction transistor. The shared pass transistor can be implemented on a microchip, such as a semiconductor integrated circuit, or can be implemented on an external device to a microchip. Throughout this disclosure, the terms “pass transistor,” “shared pass transistor,” “regulating transistor,” and “switching pass transistor” may be used interchangeably depending on the context.

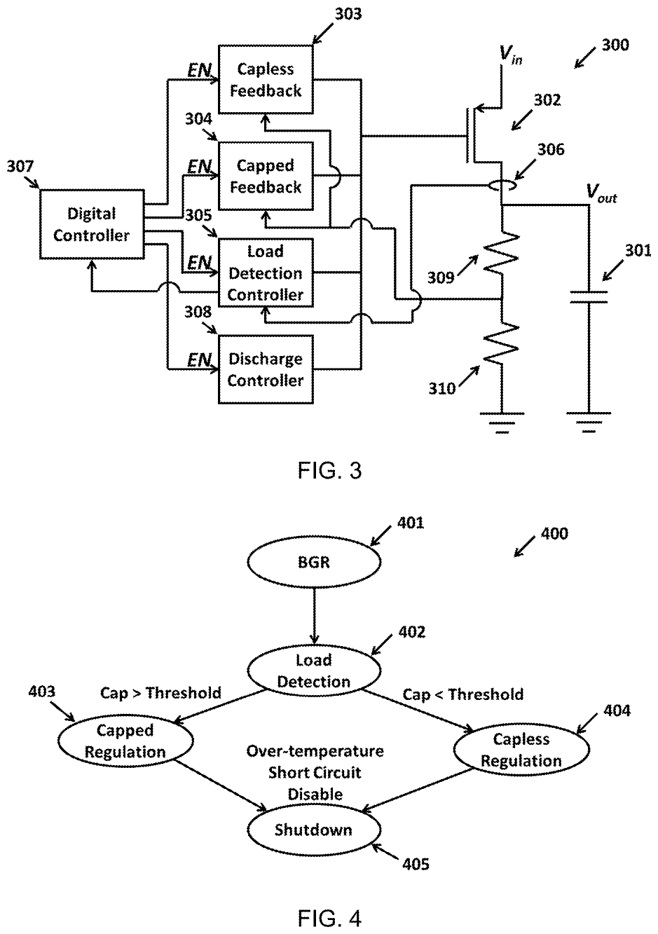

FIG. 3 shows a schematic block-level diagram of a linear regulator (300) in accordance with one embodiment of the invention. The linear regulator (300) includes a pass transistor (302) that is shared to perform several tasks depending on the functional states of the linear regulator (300). As shown in this example, a digital controller (307) may be used to select a functional state of the linear regulator (300), for example, load detection, voltage regulation, or shutdown. The digital controller (307) may generate different enabling signals for the different functional states.

In accordance with embodiments of the invention, the pass transistor (302) may be used for load regulation when no output load capacitor is used. This may be achieved by activating a no-output-capacitor feedback loop (303; capless feedback loop). When an output capacitor (301) is used, the pass transistor (302) is also used for regulation by activating an output-capacitor feedback loop (304; capped feedback loop). Both feedback loops, the capless feedback loop (303) and the capped feedback loop (304), may share the same feedback divider formed by resistors (309) and (310). In accordance with embodiments of the invention, a feedback loop (or feedback network) may comprise one or more resistors and/or capacitors to generate a signal proportional to the output voltage.

A proper choice of the feedback loop (303) or (304) requires correct detection of the output capacitor (301) value. In accordance with embodiments of the invention, a feedback loop/circuit may comprise an error amplifier, a voltage reference, and, optionally, any other components for the stability of the feedback loop. In prior art linear regulators, fixed current sources are used to charge the output node and detect the value of the output capacitor. This limits the resolution of load detection. In a linear regulator of the present invention, a load detection controller (305) may be used to control the gate voltage of the pass transistor (302) and apply a voltage ramp at the output node. The load detection controller (305) connects with a current sensor (306). With the use of the current sensor (306), the load detection controller (305) may determine the value of the output capacitor (301) and compare it to a certain threshold. Using the pass transistor (302) for applying the voltage ramp improves the resolution of load detection and saves area overhead. Using two separate feedback loops (303) and (304) for the linear regulator (300) allows the regulator to work with any output load capacitor without any stability issues.

In accordance with some embodiments of the invention, a discharge controller (308) is used when shutdown is needed. In accordance with embodiments of the invention, discharge may use the pass transistor (302) to discharge the output node provided that the pass transistor (302) is disconnected from the input. This may be accomplished by using optional blocks, such as the PSRR boost (e.g., 107 in FIG. 1) and/or current limit (e.g., 108 in FIG. 1). For example, the discharge controller (308) may be connected to a circuit at the input of the pass transistor (302) to disconnect it from the input supply and to connect the pass transistor (302) to ground, thereby allowing the output to discharge via the pass transistor (302).

FIG. 4 shows a possible state diagram of a digital controller (400) for the linear regulator (300) of FIG. 3. In the beginning, the linear regulator (300 shown in FIG. 3) is in the bandgap initialization state (401). Once the bandgap is running, the linear regulator goes to the load detection state (402) using the load detection controller. Depending on the capacitance of the output capacitor, the linear regulator goes to either the output capacitor regulation state (403) (when the capacitance>threshold) or the cap-less regulation state (404) (when the capacitance<threshold) and the corresponding feedback loop (either capped feedback loop or capless feedback loop) is used to regulate the output via the pass transistor. In either state, the linear regulator is soft started, and the output voltage is settled at the desired value. If a shutdown is needed, either for disabling the regulator, over temperature, or short circuit detection, the linear regulator goes to the shutdown state (405) and the discharge controller may be activated to discharge the output node via the pass transistor. It is clear that the pass transistor (302 in FIG. 3) performs a different task in each state and no other device is required to be connected to the output.

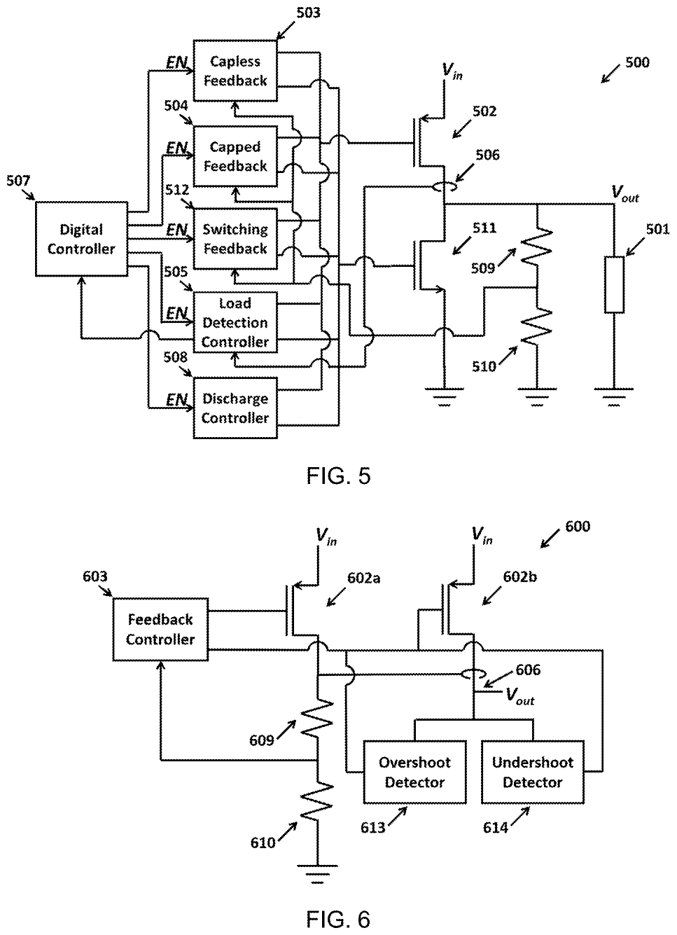

As noted above, embodiments of the invention are applicable to linear regulators and/or switching regulators. FIG. 5 shows a schematic block-level diagram of a merged linear/switching regulator (500) in accordance with one embodiment of the invention. In this example, two switching pass transistors, the first pass transistor (502) and the second pass transistor (511), are used to build a switching regulator. With the use of a load detection controller (505) and a digital controller (507), a correct feedback loop can be activated and the first pass transistor (502) may be used for a linear regulator or a switching regulator. Two feedback loops are available for the linear regulator based on the load value: a no-output-capacitor (“capless”) feedback loop (503) and an output-capacitor (“capped”) feedback loop (504). The switching regulator requires a third feedback loop, which is shown as a switching feedback loop (512). The three feedback loops may use the same divider formed by resistors (509) and (510). The second pass transistor (511) can be used in the switching regulator and/or shutdown. Shutdown may be controlled by the discharging controller (508). A current sensor (506) may be used by the load detection controller (505) to determine the output capacitor value in the load (501). In this embodiment, the first pass transistor can be a PMOS transistor, a PNP transistor, or a FinFET transistor, while the second pass transistor can be an NMOS transistor, an NPN transistor, or a FinFET transistor.

FIG. 6 shows a schematic block-level diagram of another linear regulator (600) with part of its pass transistor used in different tasks, in accordance with embodiments of the invention. The pass transistor (602) is divided into at least two parts; a larger part (602a) used for voltage regulation only, and a smaller part (602b) shared in output regulation and overshoot/undershoot regulation (i.e., overshoot/undershoot performance enhancement). That is, the smaller part (602b) is normally used for voltage regulation, and when there is overshoot/undershoot, the smaller part (602b) may be used for overshoot/undershoot regulation. The pass transistor may be an NMOS transistor, a PMOS transistor, an NPN transistor, a PNP transistor, or a FinFET transistor.

An overshoot detector (613) and an undershoot detector (614) are used to detect overshoots and undershoots, respectively, on the output voltage Vout (606) and to modify the gate voltage of the small pass transistor (602b) accordingly. The overshoot detector (613) may comprise a combination of resistors and transistors that generates a first signal (e.g., a high voltage or overshoot signal) when the regulator output quickly rises over a certain regulation threshold voltage. The undershoot detector (614) may comprise a combination of resistors and transistors that generates a second signal (e.g., a low voltage or undershoot signal) when the regulator output quickly drops under a certain regulation threshold voltage. The overshoot detector (613) and the undershoot detector (614) may be separate circuits as shown in FIG. 6, or they may be combined into the same circuit, which may be referred to as an overshoot/undershoot block. A small portion of the pass transistor (602b) may be used for overshoot/undershoot performance regulation to minimize gate capacitance and, as a result, reduce the response time of the regulator to fast load transients.

The feedback controller (603) and the resistor divider made of resistors (609) and (610) are used to complete the operation of the linear regulator and can be modified to include support for no-output-capacitor load, output-capacitor load, load detection, and/or shutdown. The feedback controller (603) may comprise an error amplifier, a voltage reference, and any necessary components needed for the stability of the feedback loop. The feedback network may be any network of resistors or capacitors that generates an output voltage proportional to the desired output voltage. The feedback controller (603) may contain a digital controller that generates the different enable signals. The feedback controller (603) may contain a load detector to determine the feedback loop required based on the output load capacitor. The feedback controller (603) may also contain a shutdown circuit.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A voltage regulator, comprising:
a load detection controller for detecting whether an output capacitor is present at an output of the voltage regulator;
a digital controller for selecting a functional state of the voltage regulator based on a signal from the load detection controller;
a first feedback loop for regulation when the output capacitor is not present;
a second feedback loop for regulation when the output capacitor is present;
a first pass transistor shared by the load detection controller, the first feedback loop, and the second feedback loop, wherein the first pass transistor is configured to work with the first or second feedback loop selected for regulation based on the functional state of the voltage regulator; and
a discharge controller connected to the first pass transistor to use the first pass transistor to discharge the output of the voltage regulator during shutdown.

2. The voltage regulator of claim 1, wherein the first feedback loop and the second feedback loop use a same feedback divider.

3. The voltage regulator of claim 1, wherein the first pass transistor is an NMOS transistor, a PMOS transistor, an NPN transistor, a PNP transistor, or a FinFET transistor.

4. The voltage regulator of claim 1, wherein the load detection controller controls a gate of the first pass transistor to generate a voltage ramp at the output and uses an output of a current sensor to determine whether the output capacitor is higher than certain threshold or not.

5. The voltage regulator of claim 1, wherein the discharge controller is configured to discharge the output of the voltage regulator by disconnecting the pass transistor from an input supply and connecting the pass transistor to ground.

6. (canceled)

7. The voltage regulator of claim 1, further comprising a second pass transistor and a third feedback loop, wherein the first pass transistor and the second pass transistor cooperate to form a switching regulator, and wherein the third feedback loop functions as a switching feedback loop.

8. The voltage regulator of claim 7, wherein the first pass transistor is a PMOS transistor, a PNP transistor, or a FinFET transistor.

9. The voltage regulator of claim 7, wherein the second pass transistor is an NMOS transistor, an NPN transistor, or a FinFET transistor.

10. The voltage regulator of claim 7, wherein the discharge controller is configured to use the first or second pass transistor to discharge the output of the voltage regulator by disconnecting the first or second pass transistor from an input supply and connecting the first or second pass transistor to ground.

11. The voltage regulator of claim 7, wherein the load detection controller controls a gate of the first pass transistor to generate a voltage ramp at the output and uses output of a current sensor to determine whether the output capacitor is higher than a threshold or not.

12. (canceled)

13. A linear voltage regulator, comprising:
a pass transistor split into at least two parts, a larger part used for voltage regulation and a smaller part used for voltage regulation or for overshoot/undershoot regulation;
an overshoot/undershoot block to detect overshoot/undershoot in an output voltage, wherein the overshoot/undershoot block comprises an overshoot controller and an undershoot controller; and
a feedback controller that comprises an error amplifier and a voltage reference.

14. The linear voltage regulator of claim 13, wherein the pass transistor is an NMOS transistor, a PMOS transistor, an NPN transistor, a PNP transistor, or a FinFET transistor.

15. The linear voltage regulator of claim 13, wherein the feedback controller comprises a digital controller to generate different enable signals, a load detector to determine the feedback loop required based on the output load capacitor, or a shutdown circuit.

16. The linear voltage regulator of claim 13, wherein the overshoot detector comprises a combination of resistors and transistors that generates a first signal when the regulator output quickly rises over a regulation threshold, and the undershoot detector is a combination of resistors and transistors that generates a second signal when the regulator output quickly drops under a regulation threshold.

17. A method for regulating an output voltage of a voltage regulator, comprising:
detecting whether an output capacitor is present at an output of the voltage regulator using a load detection controller and generating a signal;
selecting a functional state based on the signal; and
regulating an output voltage of the voltage regulator, using a first feedback loop and a first pass transistor when the functional state indicates that the output capacitor is not present, or using a second feedback loop and the first pass transistor when the functional state indicates that the output capacitor is present.

18. The method according to claim 17, further comprising:
discharging a voltage via the first pass transistor by disconnecting the first pass transistor from an input supply and connecting the first pass transistor to ground under the control of a discharge controller.

19. The method according to claim 17, wherein the voltage regulator further comprises a second pass transistor and a third feedback loop, wherein the first pass transistor and the second pass transistor cooperate to form a switching regulator, and wherein the third feedback loop functions as a switching feedback loop, the method further comprising:
regulating the output voltage using the switching regulator.

20. The method according to claim 19, further comprising:
discharging a voltage via the first or second pass transistor by disconnecting the first pass transistor and the second pass transistor from an input supply and connecting the first pass transistor and the second pass transistor to ground under the control of the discharge controller.
